(19) United States
(12) Patent Application Publication
(10) Pub. No.: US 2022/0106162 A1
(43) Pub. Date: Apr. 7, 2022

(54) CONDITION MONITORING OF AN ELEVATOR

(71) Applicant: Kone Corporation, Helsinki (FI)

(72) Inventor: Tuomo HAHL, Helsinki (FI)

(73) Assignee: Kone Corporation, Helsinki (FI)

(21) Appl. No.: 17/461,033

(22) Filed: Aug. 30, 2021

(30) Foreign Application Priority Data
Oct. 2, 2020 (EP) 20199767.3

(51) Int. Cl. B66B 5/00

(52) U.S. Cl. CPC B66B 5/0025

(57) ABSTRACT

The present invention relates to an apparatus for monitoring an operation of an elevator, the apparatus is configured to: receive a noise signal induced in an analog input of a device associated to an elevator car during an unemployment of the device in its dedicated task; compare the noise signal of the analog input to a reference signal; and set, in accordance with a comparison between the noise signal and the reference signal, a detection result to express one of the following: (i) an operation of the elevator is proper, (ii) the operation of the elevator is improper. The invention also relates to a method, to a computer program product, and to an elevator system.

### RELATED APPLICATIONS

This application claims priority to European Patent Application No. 20199767.3 filed on Oct. 2, 2020, the entire contents of which are incorporated herein by reference.

### TECHNICAL FIELD

The invention concerns in general the technical field of elevators. More particularly, the invention concerns monitoring of elevators.

### BACKGROUND

An elevator system comprises a plurality of electrical systems and devices for which cabling and wiring is arranged to achieve the elevator system to operate in a desired manner. At least part of the entities belonging to the elevator system are communicatively connected to each other so as to allowing a transfer of data between each other. Based on this starting point alone a proper operation of the elevator system requires planning of the elevator system from so-called electromagnetic compatibility (EMC) point of view which is standardized field for designing the elevator systems. Specifically, there are two main aspects to consider. First, the elevator shall not generate an excess amount of electromagnetic energy to the external environment. Second, the elevator system should not be influenced by electromagnetic radiation inducible to the elevator system from the external environment.

On the other hand, a monitoring of an operation of an elevator system is extremely important due to safe use of the elevator. Thus, the modern elevator systems are monitored in many ways in order to receive information on operational condition of the elevator system, but also for planning maintenance operations to occur at optimal instances of time to maintain the safety in using the elevators. However, typically the monitoring system and device is dedicated to monitor only one aspect of the elevator system and needed at certain instances of time, such as at an instant of departure or at an instant of arrival at landing, but otherwise it remains unused.

Hence, there is need to introduce novel approaches in applying monitoring solutions in the elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present an apparatus, a method, a computer program product, and an elevator system for monitoring an operation of an elevator.

The objects of the invention are reached by an apparatus, a method, a computer program product, and an elevator system for monitoring an operation of an elevator as defined by the respective independent claims.

According to a first aspect, an apparatus for monitoring an operation of an elevator is provided, the apparatus is configured to: receive a noise signal induced in an analog input of a device associated to an elevator car during an unemployment of the device in its dedicated task; compare the noise signal of the analog input to a reference signal; set, in accordance with a comparison between the noise signal and the reference signal, a detection result to express one of the following: (i) an operation of the elevator is proper, (ii) the operation of the elevator is improper.

The apparatus may further be configured to: generate, during the unemployment of the device in its dedicated task, a control signal to cause a travel of the elevator. For example, the noise signal is induced in the analog input in response to a generation of electromagnetic radiation caused by the elevator during its travel.

Moreover, the apparatus may be configured to generate the reference signal in an operating condition so as to represent an allowable operation of the elevator. The apparatus may be configured to cause a travel of the elevator to generate the noise signal in a same operating condition as the reference signal is generated. Furthermore, the operation condition may correspond to that the elevator car is unloaded.

The apparatus may also be configured to, in response to the detection result indicating that the operation of the elevator is improper, generate a control signal causing a prevention of the travel of the elevator.

The apparatus may further be configured to: receive a plurality of noise signals from a plurality of devices associated to respective elevator cars; and determine the reference signal on the basis of at least one of the received plurality of the noise signals. For example, the apparatus may be configured to perform a determination of the reference signal on the basis of at least one of the received plurality of the noise signals with a statistical analysis.

The apparatus may e.g. be at least one of the following: the device associated to an elevator car; an elevator controller; at least one server device accessible through a communication network.

According to a second aspect, a method for monitoring an operation of an elevator is provided, the method comprises: receiving a noise signal induced in an analog input of a device associated to an elevator car during an unemployment of the device in its dedicated task; comparing the noise signal of the analog input to a reference signal; and setting, in accordance with a comparison between the noise signal and the reference signal, a detection result to express one of the following: (i) an operation of the elevator is proper, (ii) the operation of the elevator is improper.

The method may further comprise: generating, during the unemployment of the device in its dedicated task, a control signal to cause a travel of the elevator. For example, the noise signal may be induced in the analog input in response to a generation of electromagnetic radiation caused by the elevator during its travel.

The reference signal may be generated in an operating condition so as to represent an allowable operation of the elevator. The noise signal may be generated by causing a travel of the elevator in a same operating condition as the reference signal is generated. Furthermore, the operation condition may correspond to that the elevator car is unloaded.

A control signal causing a prevention of the travel of the elevator may also be generated in response to the detection result indicating that the operation of the elevator is improper.

The method may further comprise: receiving a plurality of noise signals from a plurality of devices associated to respective elevator cars; and determining the reference signal on the basis of at least one of the received plurality of the noise signals. A determination of the reference signal may be performed on the basis of at least one of the received plurality of the noise signals with a statistical analysis.

According to a third aspect, a computer program product for monitoring an operation of an elevator is provided which computer program product, when executed by at least one processor, cause an apparatus to perform the method as described above in the context of the second aspect.

According to a fourth aspect, an elevator system is provided, the elevator system comprising: an elevator car; a device for obtaining a noise signal induced in an analog input of the device, and an apparatus as described above in the context of the first aspect.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an elevator system according to an example.

FIG. 2 illustrates schematically an apparatus according to an example.

FIG. 3 illustrates schematically a method according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

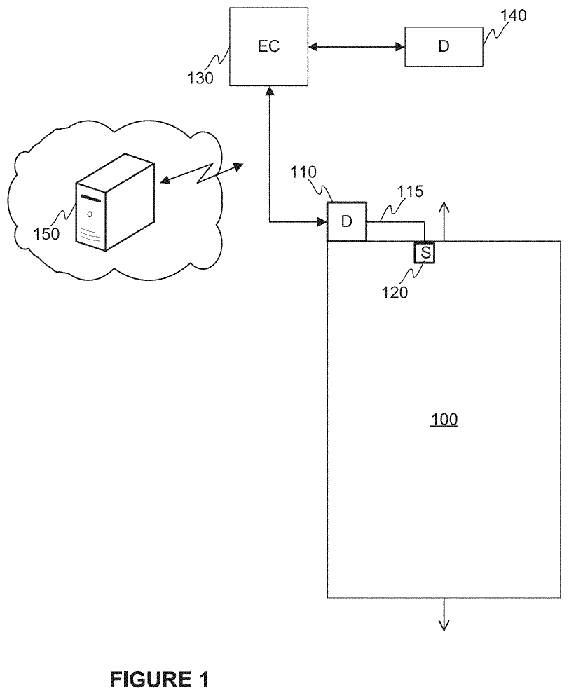

FIG. 1 illustrates schematically some aspects of an elevator environment in accordance with an example. An elevator car 100 may be arranged to travel in a shaft wherein the elevator car 100 may host a device 110, also known as a monitoring device, configured to perform a dedicated monitoring task or tasks. For example, the device 100 may be configured to determine a weight of a load of the elevator car 100. The determination of the weight may e.g. be performed at certain instance(s), such as at an instant of a departure of the elevator car 100 to travel to a destination given to the elevator car 100. The device 110 may comprise one or more sensors 120, such as pressure sensors mounted under a floor of the elevator car or strain gauge configured to generate monitoring data of an elongation of an elevator rope or an elevator belt in case of the device 110 is configured to determine the weight of the load. Generally speaking, the device 110 may receive its input from a certain source, such as the sensors 120, via a cable or a wire referred with 115 in FIG. 1. As mentioned, in accordance with an example, the device 110 may be configured perform its dedicated task, or a primary task, like weighting of the load, at known instances of an operation cycle of the elevator system, such as at a departure or at a landing or anything similar.

In accordance with an example the device 110 may be configured to perform another task at an instance deviating from the instances of the operation of the apparatus in its dedicated task. The other task is hereby called as a secondary task. The secondary task refers to a monitoring of an input signal of the device 110 at least at one instance deviating from the instance of the operation of the primary task. The signal detectable during the secondary task may be considered as a noise signal generated in the input of the device 110. More accurately, the noise signal may be induced in the input due to a state of the environment. In other words, the noise signal may represent a state of an electromagnetic field induced in the input. For example, during a travel of the elevator car 100 in the shaft the wire 115 moves in an electromagnetic field and a part of the electromagnetic field may be induced 115 in the wire due to natural laws, and as a result it may detected at an analog input of the device 110. Since the device 110 is not performing its primary task it may be concluded that the signal detectable at the analog input represents a noise caused by external environment of the device 110 outside of its primary task. Naturally, a value of the signal may be expressed with any applicable parameter, such as a voltage or a current, and this may be dependent on the type of the analog input of the device 110. In case of the elevator car 100, and its travel in the shaft, the noise signal may be expressed as a plurality of value points in a certain time frame. For example, in some examples, the noise signal may be collected during a certain travel paths, such as from a first floor to a second floor, wherein the first floor may correspond to a bottom-most floor and the second floor may correspond to a top-most floor.

Furthermore, at least part of the electromagnetic radiation in the shaft is generated in response to an operation of the elevator, and due to this the noise signal inducible in the analog input of the device 110 may be utilized for evaluating a condition of the elevator in the manner as described herein.

In the following example, the evaluation of the condition of the elevator, or another specified entity, is described in an implementation in which the apparatus performing the evaluation corresponds to the device 110 into which the noise signal is induced. Namely, in order to utilize the information received from the analog input when the apparatus is performing its secondary task there shall be available a reference signal with which the noise signal may be compared to. Advantageously, the reference signal may be determined in advance e.g. in optimal operating conditions of the elevator in question. Such an optimal operating conditions may refer to a newly installed elevator system which has passed tests and requirements to be taken into use. In such a situation the elevator system also complies with any electromagnetic compatibility related requirements. In order to generate the reference signal, and the values thereof, the elevator car 100 may be instructed to travel a predefined path to generate the reference signal in optimal environment. The travel is advantageously performed without any load. In the described manner it is possible to generate a reference signal derivable from the analog input of the device wherein the reference signal represents the operating environment at optimal operating conditions. The reference signal, and its value points, may be labeled in accordance with a need, such as with position information and/or timing information and/or any with any information defining the travel performed for generating the value points of the reference signal.

In view of the above the noise signal collected by the device 110 is advantageously obtained in the same operating conditions as the reference signal is generated. This may e.g. refer to a predefined test drive defined for the elevator system, and its performance may e.g. be controlled by an elevator controller referred with 130 in FIG. 1. For example, the elevator controller may receive data from the device 110 wherein the data indicates that there is no load in the elevator car 100 and at least by taking this into account the elevator controller 130 may generate a control signal to an electrical drive 140 to cause the elevator car 100 to travel the predefined test drive so that the device 110 is performing its secondary task during at least part of the travel for generating a noise signal being comparable to the reference signal. It shall be understood that the signals may be comparable also in a situation that there is possible to identify a predefined number of data values, such as one or more, being comparable to each other from the noise signal and the reference signal so as to perform the comparison.

The comparison, performed by the apparatus, or any other entity, receiving the noise signal and having access to the reference signal, may indicate that the noise signal deviates from the reference signal. The deviation may occur with one or more respective data values. Based on the deviation it is possible to set, in accordance with a comparison between the noise signal and the reference signal, a detection result to express one of the following: (i) an operation of the elevator is proper, (ii) the operation of the elevator is improper. In other words, the deviation may be analysed and interpreted so that the deviation results from a change in the operation of the elevator, or its operating conditions. More specifically, the analysis may indicate that the elevator system does not operate properly from EMC point of view because the noise signal induced to the analog input of the apparatus exceeds predefined limit defined by the reference signal. For example, there may be a damage in a cable shield of a cable traveling in the shaft or a damage in a filter preventing an access of the electromagnetic radiation to the shaft from a respective elevator entity, or any similar.

In case an improper operation of the elevator is detected, it may be arranged that a control signal is generated to prevent use of the elevator until a maintenance work is done to the elevator. In some example, the entity analyzing the noise signal and its deviation from the reference signal may be configured to determine a severity of the deviation based on predefined rules and generate a control signal accordingly. For example, in case of serious deviation the control signal may cause a prevention of use of the elevator, such as at least preventing a travel of the elevator, but in a less serious situation the operation of the elevator may be continued but a maintenance request is generated to a maintenance center.

In accordance with an embodiment, the entity performing the analysis, such as the apparatus or any other apparatus like the elevator controller 130, may have access to a position data of the travel path the elevator car 100 is instructed to travel for generating the noise signal for comparison. The apparatus may, hence, associate values of the noise signal with position information e.g. during the travel, or afterwards e.g. during the analysis. By doing this it is possible to derive information on a position along the travel path wherein the noise signal deviates from the reference signal and based on that to identify entities, even external to the elevator system as such, possibly causing the deviation and, hence, the improper operation of the elevator.

Furthermore, in accordance with a further embodiment an identification of a root for the noise signal may be performed so that the entity performing the analysis receives information on other sub-systems of the elevator, or even the building in which the elevator under monitoring resides. Hence, the entity, such as the apparatus, may detect that another sub-system is active, e.g. in a plurality of times, when the detection of the noise signal is done. For example, the entity performing the analysis may detect that every time the noise signal is present an elevator door is operating, i.e. being either opening or closing. In addition to this, it may perform additional detections, such that the elevator car is stationary when the noise signal is present. Based on this kind of sub-detection the entity performing the analysis may conclude that the elevator door generates the noise signal and it is not operating in a proper way.

Furthermore, in some examples an operation for performing the method may be arranged so that the entity, such as the apparatus, configured to perform the method, or at least at least the analysis part, may be configured to generate, during the unemployment of the device to perform in its dedicated task i.e. the primary task, a control signal to cause a travel of the elevator. This may e.g. be arranged so that the apparatus 110 is configured to generate a control signal to the elevator controller 130 which, in turn, is configured to generate a control signal to power generation means, such as to the elevator drive 140, to cause the travel.

For sake of clarity it shall be understood that a detection that the device, or any other respective entity, is unemployed from its primary, or dedicated, task may be based on a variety of criteria. For example, it may be detected based on a state of the elevator system, such as the elevator car resides at landing i.e. not moving in the shaft, or vice versa. Alternatively or in addition, the detection may be based on data obtainable from another system, or data stored in data storage accessible by an entity performing the detection. For example, in some situation the device may be controlled to be prevented to perform its dedicated operation wherein an indication of this is stored in the data storage, and the detection of the unemployment of the device in question may be based on the analysis of the indication. Generally speaking, the present invention may obtain the information, and, hence, perform the detection of the unemployment, based on data obtainable from a plurality of sources.

As mentioned, the foregoing description is mainly given with respect to an implementation in which the apparatus configured to perform analysis, such as at least the comparison and the setting of the detection result may be the one traveling with the elevator car, such as the device referred with 110 in FIG. 1, and which is configured to perform the secondary task, and hence receiving, e.g. by a detection, the noise signal. However, the present invention may also be implemented so that at least the analysis portion of the method, i.e. at least the comparison step and the setup the detection result step, or at least one of them, may be performed by any other device arranged to detect the measurement data induced in the analog input of a device traveling along with the elevator car 100. For example, the apparatus configured to perform the analysis portion may be the device 110 whose analog input the noise signal is induced to, the elevator controller 130 or any other device external to the one into whose analog input the noise signal is induced to, such as one or more server devices 150 residing in a communication network 160 and configured to operate as a cloud computing environment. Alternatively or in addition, it may be arranged so that one entity performs a first portion of the method and another entity performs a second portion of the method. For example, the operation may be shared between the apparatus and the elevator controller 130 or with the one or more server devices. In view of above, the apparatus may be understood as a single device or as a plurality of entities configured to operate as a distributed computing environment. In some embodiments, the apparatus, such as at least one server device, may reside in the communication network and configured to receive the noise signals from a plurality of elevators being e.g. similar kind of systems, and perform the monitoring method for the plurality of elevators as described. Alternatively or in addition, the entity receiving the signal from the analog inputs of the devices 110 associated to the respective elevator cars of the different elevators may be arranged to determine the reference signal on a basis of the received information. For example, the entity may set one of the signals as the reference signal to be used with in the comparison for other elevators. In another embodiment, the entity may be configured to determine the reference signal based on the received signals, such as by performing a statistical analysis for the received data. For example, it may determine an average from the received noise signals and use that as the reference in the comparison.

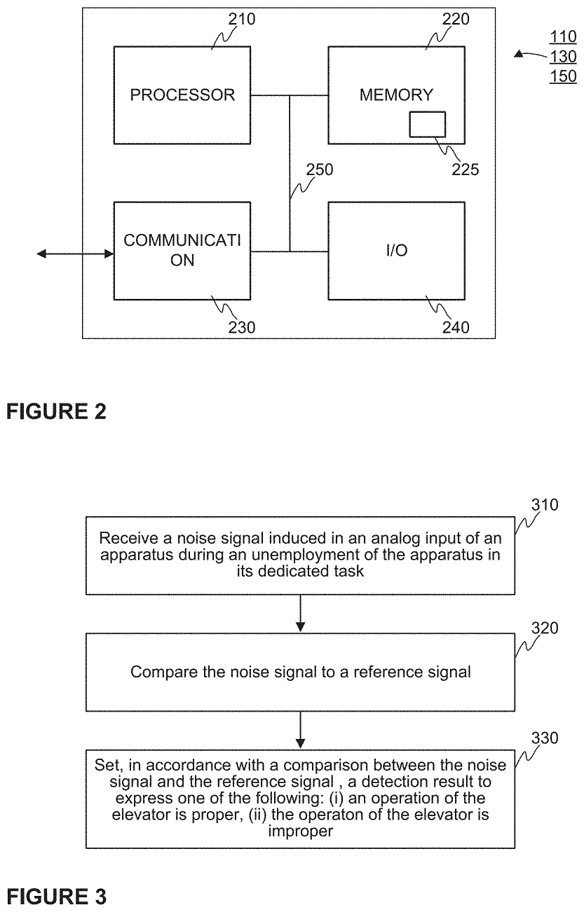

For example, an apparatus configured to perform at least a part of a method as described herein may refer to a computing device, such as a server device, a laptop computer, a PC, or any similar data processing device, as schematically illustrated in FIG. 2. FIG. 2 illustrates schematically as a block diagram a non-limiting example of the apparatus applicable to perform the method in cooperation with other entities if necessary. The apparatus may thus be the device referred with 110 in FIG. 1, the elevator controller 130, or a server device 150, for example. For sake of clarity, it is worthwhile to mention that the block diagram of FIG. 2 depicts some components of a device that may be employed to implement an operation of the apparatus. The apparatus comprises a processor 210 and a memory 220. The memory 220 may store data and computer program code 225. The apparatus may further comprise communication means 230 for wired and/or wireless communication with other entities. Furthermore, I/O (input/output) components 240 may be arranged, together with the processor 210 and a portion of the computer program code 225, to provide a user interface for receiving input from a user, such as from a technician of the elevator system, and/or providing output to the user of the system when necessary. In particular, the user I/O components may include user input means, such as one or more keys or buttons, a keyboard, a touchscreen, or a touchpad, etc. The user I/O components may include output means, such as a display or a touchscreen. The components of the apparatus may be communicatively coupled to each other via a bus 250 that enables transfer of data and control information between the components.

The memory 220 and a portion of the computer program code 225 stored therein may be further arranged, with the processor 210, to cause the apparatus, i.e. the device, to perform a method as described in the foregoing description. The processor 210 may be configured to read from and write to the memory 220. Although the processor 210 is depicted as a respective single component, it may be implemented as respective one or more separate processing components. Similarly, although the memory 220 is depicted as a respective single component, it may be implemented as respective one or more separate components, some or all of which may be integrated/removable and/or may provide permanent/semi-permanent/dynamic/cached storage.

The computer program code 225 may comprise computer-executable instructions that implement functions that correspond to steps of the method when loaded into the processor 210. As an example, the computer program code 225 may include a computer program consisting of one or more sequences of one or more instructions. The processor 210 is able to load and execute the computer program by reading the one or more sequences of one or more instructions included therein from the memory 220. The one or more sequences of one or more instructions may be configured to, when executed by the processor 210, cause the apparatus to perform the method be described herein. Hence, the apparatus may comprise at least one processor 210 and at least one memory 220 including the computer program code 225 for one or more programs, the at least one memory 220 and the computer program code 225 configured to, with the at least one processor 210, cause the apparatus to perform the method as described.

The computer program code 225 may be provided e.g. a computer program product comprising at least one computer-readable non-transitory medium having the computer program code 225 stored thereon, which computer program code 225, when executed by the processor 210 causes the apparatus to perform the method. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 225 may comprise a proprietary application, such as computer program code for causing an execution of the method in the manner as described in the description herein.

Any of the programmed functions mentioned may also be performed in firmware or hardware adapted to or programmed to perform the necessary tasks.

Moreover, as mentioned a functionality of the apparatus may be shared between a plurality of devices as a distributed computing environment. For example, the distributed computing environment may comprise a plurality of devices as schematically illustrated in FIG. 2 arranged to implement the method in cooperation with each other in a predetermined manner. For example, each device may be arranged to perform one or more method steps and in response to a finalization of its dedicated step it may hand a continuation of the process to the next device. The devices may e.g. be the apparatus referred with 110 in FIG. 1 and the elevator controller 130, or even a server device, or any combination of these as long as at least part of the data representing the noise signal experience in the analog input of the apparatus 110, or in the analog input of another device, may be conveyed to the respective entities.

Hence, in accordance with some aspects an elevator is provided wherein the elevator system comprises an apparatus to perform the method as is described herein. The apparatus may be the monitoring device referred with 110 in FIG. 1, the elevator controller 130, or a server device, for example. In the method it is monitored an operation of an elevator first by receiving 310 a noise signal induced in an analog input of an apparatus associated to an elevator car 100 during an unemployment of the device in its dedicated task. Next, the noise signal is compared 320 to a reference signal accessible to the apparatus performing the method. For example, the reference signal may be stored in internal memory of the apparatus or an external data storage accessible by the apparatus. Finally, a detection result is set 330, in accordance with a comparison between the noise signal and the reference signal, to express one of the following: (i) an operation of the elevator is proper, (ii) the operation of the elevator is improper. Still further, the method may comprise other operations as already described in the foregoing description.

Some aspects of the invention relate to an elevator system comprising an elevator car 100 with which a device 110 is associated to collect measurement data from an analog input of the device 110, and an entity configured to perform the method as described above. In some examples, the entity corresponds to the apparatus which may also be integrated with the device 110, for example. Naturally, the entities being involved in the method, and the solution, may either be directly or indirectly communicatively connected to each other.

The specific examples provided in the description given above should not be construed as limiting the applicability and/or the interpretation of the appended claims. Lists and groups of examples provided in the description given above are not exhaustive unless otherwise explicitly stated.

1. An apparatus for monitoring an operation of an elevator, the apparatus is configured to:
receive a noise signal induced in an analog input of a device associated to an elevator car during an unemployment of the device in its dedicated task,
compare the noise signal of the analog input to a reference signal,
set, in accordance with a comparison between the noise signal and the reference signal, a detection result to express one of the following: (i) an operation of the elevator is proper, (ii) the operation of the elevator is improper.

2. The apparatus of claim 1, the apparatus is further configured to:
generate, during the unemployment of the device in its dedicated task, a control signal to cause a travel of the elevator.

3. The apparatus of claim 2, wherein the noise signal is induced in the analog input in response to a generation of electromagnetic radiation caused by the elevator during its travel.

4. The apparatus of claim 1, wherein the apparatus is configured to generate the reference signal in an operating condition so as to represent an allowable operation of the elevator.

5. The apparatus of claim 4, wherein the apparatus is configured to cause a travel of the elevator to generate the noise signal in a same operating condition as the reference signal is generated.

6. The apparatus of claim 4, wherein the operation condition corresponds to that the elevator car is unloaded.

7. The apparatus of claim 1, wherein the apparatus is configured to, in response to the detection result indicating that the operation of the elevator is improper, generate a control signal causing a prevention of the travel of the elevator.

8. The apparatus of claim 1, the apparatus is further configured to:
receive a plurality of noise signals from a plurality of devices associated to respective elevator cars, and
determine the reference signal on the basis of at least one of the received plurality of the noise signals.

9. The apparatus of claim 8, wherein the apparatus is configured to perform a determination of the reference signal on the basis of at least one of the received plurality of the noise signals with a statistical analysis.

10. The apparatus of claim 1, wherein the apparatus is at least one of the following: the device associated to an elevator car; an elevator controller; at least one server device accessible through a communication network.

11. A method for monitoring an operation of an elevator, the method comprises:
receiving a noise signal induced in an analog input of a device associated to an elevator car during an unemployment of the device in its dedicated task,
comparing the noise signal of the analog input to a reference signal,
setting, in accordance with a comparison between the noise signal and the reference signal, a detection result to express one of the following: (i) an operation of the elevator is proper, (ii) the operation of the elevator is improper.

12. The method of claim 11, the method further comprises:
generating, during the unemployment of the device in its dedicated task, a control signal to cause a travel of the elevator.

13. The method of claim 12, wherein the noise signal is induced in the analog input in response to a generation of electromagnetic radiation caused by the elevator during its travel.

14. The method of claim 11, wherein the reference signal is generated in an operating condition so as to represent an allowable operation of the elevator.

15. The method of claim 14, wherein the noise signal is generated by causing a travel of the elevator in a same operating condition as the reference signal is generated.

16. The method of claim 14, wherein the operation condition corresponds to that the elevator car is unloaded.

17. The method of claim 11, wherein a control signal causing a prevention of the travel of the elevator is generated in response to the detection result indicating that the operation of the elevator is improper.

18. The method of claim 11, the method further comprising:
receiving a plurality of noise signals from a plurality of devices associated to respective elevator cars, and
determining the reference signal on the basis of at least one of the received plurality of the noise signals.

19. The method of claim 18, wherein a determination of the reference signal is performed on the basis of at least one of the received plurality of the noise signals with a statistical analysis.

20. A computer program product for monitoring an operation of an elevator which, when executed by at least one processor, cause an apparatus to perform the method according to claim 10.

21. An elevator system, comprising:
an elevator car,
a device for obtaining a noise signal induced in an analog input of the device, and
an apparatus according to claim 1.
